(19) United States
(12) Patent Application Publication
(10) Pub. No.: US 2014/0344022 A1
(43) Pub. Date: Nov. 20, 2014

(54) COMPETITOR RESPONSE MODEL BASED PRICING TOOL

(71) Applicant: BANK OF AMERICA CORPORATION, Charlotte, NC (US)

(72) Inventor: Jason Thalken, Austin, TX (US)

(73) Assignee: BANK OF AMERICA CORPORATION, Charlotte, NC (US)

(21) Appl. No.: 13/893,784

(22) Filed: May 14, 2013

(51) Int. Cl. G06Q 30/02

(52) U.S. Cl. CPC G06Q 30/0206
USPC 705/7.35

(57) ABSTRACT

Embodiments of the present invention relate to apparatuses, systems, methods, and computer program products for determining an optimal price recommendation. In one embodiment, a system comprises a processor configured to: (a) predict one or more values of relative strength index based on one or more price changes; (b) determine a curve for predicted relative strength index as a function of price change; (c) use elasticity models to determine values of market share based on the predicted values of relative strength index to thereby determine a market share as a function of price change curve; (d) determine a curve for total revenue as a function of price change curve; (e) determine an optimal price or an optimal price change for the entity based at least partially on a value associated with a peak of the curve for total revenue as the function of price change.

### FIELD

In general, embodiments of the present invention relate to apparatuses, systems, methods, and computer program products for using a competitor response model.

### BACKGROUND

It is not uncommon to find that many financial institutions price one or more of their financial products relative to the pricing of their peers in competition. In many cases, competing financial institutions may seek to capitalize on a pricing change by being one of the first in the market to do so and as a result, reap additional benefits such a gain in market share for a product and/or a gain in additional revenue for the product. In these instances, it is likely that a competitor of the first moving financial institution will quickly follow suit in order to regain its competitive position in a targeted product market and therefore, virtually eliminate any or all of the added gains of the first moving financial institution. Accordingly, it would be desirable if there was something that would help a first moving financial institution determines an appropriate price change that would help minimize or eliminate the subsequent effects of its competitors' responses to its gained market share and/or revenue. In particular, it would be desirable if there were an apparatus, system, method, and/or computer program product configured to determine a competitors pricing strategy, predict competitor pricing, and provide optimal pricing recommendations so that a financial institution changing its pricing for a product may obtain lasting gains in a competitive market.

### SUMMARY OF SELECTED EMBODIMENTS OF THE INVENTION

### Brief Overview

The following presents a simplified summary of one or more embodiments of the invention in order to provide a basic understanding of such embodiments. This summary is not an extensive overview of all contemplated embodiments and is not intended to identify key or critical elements of all embodiments or delineate the scope of any or all embodiments. Its sole purpose is to present some concepts of one or more embodiments in a simplified form as a prelude to the more detailed description that is presented later.

### Brief Summary of Competitor Pricing Strategy Determination

Some embodiments of the present invention provide a system for determining a pricing strategy that includes: a computing platform including at least one processing device and a storage device; a software module stored in the storage device, comprising executable instructions that when executed by the computer processing device causes the processing device to: (a) receive information identifying pricing strategy for each of the plurality of entities, where the pricing strategy comprises at least one variable for a price selection method; (b) randomly generate initial values for the at least one variable for the price selection method to thereby generate a plurality of pricing strategies; (c) determine a value of fitness for each of the plurality of pricing strategies based at least partially on evaluating each of the plurality of pricing strategies using the historical data; (d) select pricing strategies from among the plurality of pricing strategies having a value of fitness that satisfy a predetermined criteria; (e) use a genetic algorithm to randomly modify a portion of the initial values for the at least one price selection method; and (f) determine that the plurality of pricing strategies is satisfactory.

In some embodiments of the system, the plurality of entities is a group of competitors/lenders in a first mortgage market segment.

In some embodiments of the system, the price selection method is one of a rank method, percentile method, follow the leader method, or revenue optimizer.

In some embodiments of the system, the predetermined criteria for selecting pricing strategies from among the plurality of strategies relates to predetermined thresholds of standard deviation from an average fitness value for the plurality of pricing strategies.

In some embodiments of the system, the value of fitness for each of the plurality of pricing strategies is determined by calculating a difference between an average price value determined using each of the plurality of pricing strategies when evaluated over the historical and a historical average price value.

In some embodiments of the system, the software module further comprises executable instructions that when executed by the processor cause the processor to: receive a portion of the initial values for the at least one variable from prior strategies.

In some embodiments of the system, the pricing strategy may further comprises any one or more additional variables including margin minimum, volume maximum, volume minimum, maximum daily change, off-model buffer, strategy type, market share target, margin target, volume management, and/or rank method for high volume only.

In one aspect of the invention, a method is provided for determining a pricing strategy. The method includes using a computer processor to execute computer program code instructions stored in one or more non-transitory computer-readable mediums, wherein said computer program code instructions are structured to cause said computer processor to: (a) receive information identifying pricing strategy for each of the plurality of entities, where the pricing strategy comprises at least one variable for a price selection method; (b) randomly generate initial values for the at least one variable for the price selection method to thereby generate a plurality of pricing strategies; (c) determine a value of fitness for each of the plurality of pricing strategies based at least partially on evaluating each of the plurality of pricing strategies using the historical data; (d) select pricing strategies from among the plurality of pricing strategies having a value of fitness that satisfy a predetermined criteria; (e) use a genetic algorithm to randomly modify a portion of the initial values for the at least one price selection method; and (f) determine that the plurality of pricing strategies is satisfactory.

In some embodiments of the method, the plurality of entities is a group of competitors/lenders in a first mortgage market segment.

In some embodiments of the method, the price selection method is one of a rank method, percentile method, follow the leader method, or revenue optimizer.

In some embodiments of the method, the predetermined criteria for selecting pricing strategies from among the plurality of strategies relates to predetermined thresholds of standard deviation from an average fitness value for the plurality of pricing strategies.

In some embodiments of the method, the value of fitness for each of the plurality of pricing strategies is determined by calculating a difference between an average price value determined using each of the plurality of pricing strategies when evaluated over the historical and a historical average price value.

In some embodiments of the method, further comprise computer program code instructions that are structured to cause said computer processor to: receive a portion of the initial values for the at least one variable from prior strategies.

In some embodiments of the method, the pricing strategy may further comprises any one or more additional variables including margin minimum, volume maximum, volume minimum, maximum daily change, off-model buffer, strategy type, market share target, margin target, volume management, and/or rank method for high volume only.

In another aspect, a computer program product for determining a pricing strategy is provided that includes a non-transitory computer-readable medium, wherein the non-transitory computer-readable medium comprises one or more computer-executable program code portions that, when executed by a computer, cause the computer to: (a) receive information identifying pricing strategy for each of the plurality of entities, where the pricing strategy comprises at least one variable for a price selection method; (b) randomly generate initial values for the at least one variable for the price selection method to thereby generate a plurality of pricing strategies; (c) determine a value of fitness for each of the plurality of pricing strategies based at least partially on evaluating each of the plurality of pricing strategies using the historical data; (d) select pricing strategies from among the plurality of pricing strategies having a value of fitness that satisfy a predetermined criteria; (e) use a genetic algorithm to randomly modify a portion of the initial values for the at least one price selection method; and (f) determine that the plurality of pricing strategies is satisfactory.

In some embodiments of the computer program product, the plurality of entities is a group of competitors/lenders in a first mortgage market segment.

In some embodiments of the computer program product, the price selection method is one of a rank method, percentile method, follow the leader method, or revenue optimizer.

In some embodiments of the computer program product, the predetermined criteria for selecting pricing strategies from among the plurality of strategies relates to predetermined thresholds of standard deviation from an average fitness value for the plurality of pricing strategies.

In some embodiments of the computer program product, the value of fitness for each of the plurality of pricing strategies is determined by calculating a difference between an average price value determined using each of the plurality of pricing strategies when evaluated over the historical and a historical average price value.

In some embodiments of the computer program product, further comprises computer-readable code that when executed by a computer processor causes the computer to: receive a portion of the initial values for the at least one variable from prior strategies.

### Brief Summary of Competitor Pricing Strategy Determination

Some embodiments of the present invention provide a system for predicting prices for a plurality of entities that includes: a computing platform including at least one processing device and a storage device; a software module stored in the storage device, comprising executable instructions that when executed by the computer processing device causes the processing device to: (a) receive information identifying an effective pricing strategy for each of the plurality of entities; (b) receive a selection of an entity from among the plurality of entities; (c) use the historical data to determine recent pricing data for each of the plurality of entities to thereby determine a group of recent pricing data, wherein the recent pricing data is an average price value or a price value for a defined historical period of time; (d) select pricing data associated with the selected entity from among the group of recent pricing data; (e) modify the selected price data by increasing or decreasing the average price value or the price value associated with the selected price data thereby generating a modified price data for the selected entity; (f) substitute the selected price data from the group of recent pricing data with the modified price data thereby generating a modified group of recent pricing data; and (g) apply the effective pricing strategy for each of the plurality of entities to the modified group of recent pricing data.

In some embodiments of the system, the software module further comprises executable instructions that when executed by the processor cause the processor to: predict a future price for each of the plurality of entities based at least partially on the application of the effective pricing strategy for each of the plurality of entities to the modified group of pricing data.

In some embodiments of the system, the plurality of entities is a group of competitors/lenders in a first mortgage market segment.

In some embodiments of the system, the recent pricing data comprising average price values or price values of the most recent historical week.

In some embodiments of the system, the recent pricing data relates to average price or price values for a specific market segment in which all of the plurality of entities compete.

In some embodiments of the system, the effective pricing strategy comprises a price selection method and one or more variables, where the price selection method and one or more variables have associated optimal values that best approximate the pricing behaviors of an entity.

In some embodiments of the system, the software module further comprises executable instructions that when executed by the processor cause the processor to: determine a price change for each of the plurality of entities by calculating a difference between the predicted future price for each entity and the average price value or price value for each entity determined from the recent pricing data.

In one aspect of the invention, a method is provided for predicting prices for a plurality of entities. The method includes using a computer processor to execute computer program code instructions stored in one or more non-transitory computer-readable mediums, wherein said computer program code instructions are structured to cause said computer processor to: (a) receive information identifying an effective pricing strategy for each of the plurality of entities; (b) receive a selection of an entity from among the plurality of entities; (c) use the historical data to determine recent pricing data for each of the plurality of entities to thereby determine a group of recent pricing data, wherein the recent pricing data is an average price value or a price value for a defined historical period of time; (d) select pricing data associated with the selected entity from among the group of recent pricing data; (e) modify the selected price data by increasing or decreasing the average price value or the price value associated with the selected price data thereby generating a modified price data for the selected entity; (f) substitute the selected price data from the group of recent pricing data with the modified price data thereby generating a modified group of recent pricing data; and (g) apply the effective pricing strategy for each of the plurality of entities to the modified group of recent pricing data.

In some embodiments of the method, further comprise computer program code instructions that are structured to cause said computer processor to: predict a future price for each of the plurality of entities based at least partially on the application of the effective pricing strategy for each of the plurality of entities to the modified group of pricing data.

In some embodiments of the method, the plurality of entities is a group of competitors/lenders in a first mortgage market segment.

In some embodiments of the method, the recent pricing data comprising average price values or price values of the most recent historical week.

In some embodiments of the method, the recent pricing data relates to average price or price values for a specific market segment in which all of the plurality of entities compete.

In some embodiments of the method, the effective pricing strategy comprises a price selection method and one or more variables, where the price selection method and one or more variables have associated optimal values that best approximate the pricing behaviors of an entity.

In some embodiments of the method, further comprise computer program code instructions that are structured to cause said computer processor to: determine a price change for each of the plurality of entities by calculating a difference between the predicted future price for each entity and the average price value or price value for each entity determined from the recent pricing data.

In another aspect, a computer program product for predicting prices for a plurality of entities is provided that includes a non-transitory computer-readable medium, wherein the non-transitory computer-readable medium comprises one or more computer-executable program code portions that, when executed by a computer, cause the computer to: (a) receive information identifying an effective pricing strategy for each of the plurality of entities; (b) receive a selection of an entity from among the plurality of entities; (c) use the historical data to determine recent pricing data for each of the plurality of entities to thereby determine a group of recent pricing data, wherein the recent pricing data is an average price value or a price value for a defined historical period of time; (d) select pricing data associated with the selected entity from among the group of recent pricing data; (e) modify the selected price data by increasing or decreasing the average price value or the price value associated with the selected price data thereby generating a modified price data for the selected entity; (f) substitute the selected price data from the group of recent pricing data with the modified price data thereby generating a modified group of recent pricing data; and (g) apply the effective pricing strategy for each of the plurality of entities to the modified group of recent pricing data.

In some embodiments of the computer program product, further comprises computer-readable code that when executed by a computer processor causes the computer to: predict a future price for each of the plurality of entities based at least partially on the application of the effective pricing strategy for each of the plurality of entities to the modified group of pricing data.

In some embodiments of the computer program product, the plurality of entities is a group of competitors/lenders in a first mortgage market segment.

In some embodiments of the computer program product, the recent pricing data comprising average price values or price values of the most recent historical week.

In some embodiments of the computer program product, the recent pricing data relates to average price or price values for a specific market segment in which all of the plurality of entities compete.

In some embodiments of the computer program product, the effective pricing strategy comprises a price selection method and one or more variables, where the price selection method and one or more variables have associated optimal values that best approximate the pricing behaviors of an entity.

### Brief Summary of Competitor Pricing Strategy Determination

Some embodiments of the present invention provide a system for determining an optimal price recommendation that includes: a computing platform including at least one processing device and a storage device; a software module stored in the storage device, comprising executable instructions that when executed by the computer processing device causes the processing device to: (a) determine a current value of margin for an entity; (b) predict one or more values of relative strength index based on one or more price changes; (c) determine a curve for predicted relative strength index as a function of price change based at least partially on the one or more price changes and predicted one or more values of relative strength index; (d) use one or more elasticity models to determine one or more values of market share based at least partially on the predicted one or more values of relative strength index to thereby determine a market share as a function of price change curve; (e) determine a curve for total revenue as a function of price change curve by multiplying the market share of the market share as a function of price change curve by current margin; (f) determine an optimal price or an optimal price change for the entity based at least partially on a value associated with a peak of the curve for total revenue as the function of price change.

In some embodiments of the system, predicting one or more values of relative strength index comprises: (a) predicting a future price for the entity; (b) predicting a future price for each of the competitors of the entity in a specific market segment; (c) predicting a future weighted average price per volume of sales for competitors of the entity in a specific market segment; and (d) calculating a value of the difference between the future price for the entity and the future weighted average price per volume for competitors of the entity.

In some embodiments of the system, determining the curve for predicted relative strength index as a function of price change includes simulating 601 different scenarios in which the entity changes it price for a specific market segment, where each scenario includes a result of a value for relative strength index of the entity.

In some embodiments of the system, the price changes for the simulations range from −300 basis points to +300 basis points.

In some embodiments of the system, the processor is further configured to: provide an optimal price change and/or an optimal price recommendation for the entity and analysis comprising a description specifying how each competitor of the entity reacts to the optimal price change and/or the optimal price recommendation.

In some embodiments of the system, the one or more elasticity models includes at least one demand elasticity model for a product that is sold or offered for sale by the entity.

In some embodiments of the system, the current value of margin for the entity is based at least partially on a difference between a price value at which the entity sells or offers to sell a product and a cost basis for the product.

In one aspect of the invention, a method is provided for determining an optimal price recommendation. The method includes using a computer processor to execute computer program code instructions stored in one or more non-transitory computer-readable mediums, wherein said computer program code instructions are structured to cause said computer processor to: (a) determine a current value of margin for an entity; (b) predict one or more values of relative strength index based on one or more price changes; (c) determine a curve for predicted relative strength index as a function of price change based at least partially on the one or more price changes and predicted one or more values of relative strength index; (d) use one or more elasticity models to determine one or more values of market share based at least partially on the predicted one or more values of relative strength index to thereby determine a market share as a function of price change curve; (e) determine a curve for total revenue as a function of price change curve by multiplying the market share of the market share as a function of price change curve by current margin; (f) determine an optimal price or an optimal price change for the entity based at least partially on a value associated with a peak of the curve for total revenue as the function of price change.

In some embodiments of the method, predicting one or more values of relative strength index comprises: (a) predicting a future price for the entity; (b) predicting a future price for each of the competitors of the entity in a specific market segment; (c) predicting a future weighted average price per volume of sales for competitors of the entity in a specific market segment; and (d) calculating a value of the difference between the future price for the entity and the future weighted average price per volume for competitors of the entity.

In some embodiments of the method, determining the curve for predicted relative strength index as a function of price change includes simulating 601 different scenarios in which the entity changes it price for a specific market segment, where each scenario includes a result of a value for relative strength index of the entity.

In some embodiments of the method, the price changes for the simulations range from −300 basis points to +300 basis points.

In some embodiments of the method, further comprises computer program instructions that when executed causes the processor to: provide an optimal price change and/or an optimal price recommendation for the entity and analysis comprising a description specifying how each competitor of the entity reacts to the optimal price change and/or the optimal price recommendation.

In some embodiments of the method, the one or more elasticity models includes at least one demand elasticity model for a product that is sold or offered for sale by the entity.

In some embodiments of the method, the current value of margin for the entity is based at least partially on a difference between a price value at which the entity sells or offers to sell a product and a cost basis for the product.

In another aspect, a computer program product for determining an optimal price recommendation is provided that includes a non-transitory computer-readable medium, wherein the non-transitory computer-readable medium comprises one or more computer-executable program code portions that, when executed by a computer, cause the computer to: (a) determine a current value of margin for an entity; (b) predict one or more values of relative strength index based on one or more price changes; (c) determine a curve for predicted relative strength index as a function of price change based at least partially on the one or more price changes and predicted one or more values of relative strength index; (d) use one or more elasticity models to determine one or more values of market share based at least partially on the predicted one or more values of relative strength index to thereby determine a market share as a function of price change curve; (e) determine a curve for total revenue as a function of price change curve by multiplying the market share of the market share as a function of price change curve by current margin; (f) determine an optimal price or an optimal price change for the entity based at least partially on a value associated with a peak of the curve for total revenue as the function of price change.

In some embodiments of the computer program product, predicting one or more values of relative strength index comprises: (a) predicting a future price for the entity; (b) predicting a future price for each of the competitors of the entity in a specific market segment; (c) predicting a future weighted average price per volume of sales for competitors of the entity in a specific market segment; and (d) calculating a value of the difference between the future price for the entity and the future weighted average price per volume for competitors of the entity.

In some embodiments of the computer program product, determining the curve for predicted relative strength index as a function of price change includes simulating 601 different scenarios in which the entity changes it price for a specific market segment, where each scenario includes a result of a value for relative strength index of the entity.

In some embodiments of the computer program product, the price changes for the simulations range from −300 basis points to +300 basis points.

In some embodiments of the computer program product, further comprising computer program code instructions such that when executed causes the computer to: provide an optimal price change and/or an optimal price recommendation for the entity and analysis comprising a description specifying how each competitor of the entity reacts to the optimal price change and/or the optimal price recommendation.

In some embodiments of the computer program product, the one or more elasticity models includes at least one demand elasticity model for a product that is sold or offered for sale by the entity.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a flow diagram illustrating a general process flow 100 of a system for determining a pricing strategy is provided, in accordance with one embodiment of the present invention.

FIG. 2 is a flow diagram illustrating a modified process flow 200 of a system for determining a pricing strategy of a competitor is provided, in accordance with one embodiment of the present invention.

FIG. 3 is a flow diagram illustrating a general process flow 300 of a system for determining a predicted price or price change of a competitor, in accordance with one embodiment of the invention.

FIG. 4 is a flow diagram illustrating a general process flow 400 of a system for predicting prices for a market, in accordance with one embodiment of the invention.

FIG. 5 is a flow diagram illustrating a general process flow 500 of a system for predicting prices of competitors based on or in response to an initial change in price by one of the competitors, in accordance with one embodiments of the invention.

FIG. 6 is a flow diagram illustrating a general process flow of a system for determining price recommendations based on determining a weighted average price for competitors in a specific product market and a resulting relative strength index (RSI) for a competitor, in accordance with one embodiment of the invention.

FIG. 7 is block diagram illustrating a competitor response model system 700, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa unless explicitly stated otherwise. Also, as used herein, the term “a” and/or “an” shall mean “one or more,” even though the phrase “one or more” is also used herein. Like numbers refer to like elements throughout.

It will be understood that the term “fitness,” as used herein, refers to a measure used for measuring the performance of a model and/or a system using a model. Fitness is a type of objective measure that may be used to summarize how close a given model or design solution is to achieving the set aims of the model. In most embodiments, fitness may be measured using a single figure of merit to indicate how close a model or solution set is to the set aims of the model. For example, a model may be designed to produce potential solution sets for determining a pricing strategy of a competitor. The model may produce potential solution sets that include various pricing strategies that the competitor may use. The solution sets may then be tested over historical data relating to the pricing practices of the competitor in order to determine how close the model values are to the actual historical values. Thus, in this case, the fitness may be the absolute distance between an average of the model prices and actual historical prices of the competitor. Thus, in many embodiments, fitness can be interpreted as an average distance between predicted values (using a model) and actual values. In the present application, fitness may be measured in basis points or any other related metric.

It will be understood that the phrase “genetic algorithm,” as used herein, refers to an optimization heuristic that mimics the process of natural evolution. This heuristic (also sometime called a metaheuristic) is may be used to generate useful solutions to optimization problems. Additionally, genetic algorithms belong to a larger class of evolutionary algorithms, which generate solutions to optimization problems using techniques inspired by natural evolution, such as inheritance, mutation, selection, and crossover.

It will be understood that the phrase “inverse problem solving method,” as used herein, refers to a general framework that can be used to convert observed measurements into information about a specific system.

In general terms, embodiments of the present invention are directed to apparatus, systems, computer program products, and methods for determining a pricing strategy for a competitor, predict competitor pricing in a product segment, and determine optimal pricing recommendations based on a competitor response model. Presently, many approaches, including time-series analysis and regression modeling, have been used and are used in attempts to predict competitor behavior in the marketplace. However, because competitor pricing changes depend on a large number of factors, which look like noise unless carefully examined, these approaches are used without meaningful and/or positive results. The embodiments of the present invention use a novel approach for predicting competitor behavior in the marketplace and for predicting future changes and movements in the marketplace that occur in response to a change in prices by one of the competitors within a group of competitors. This novel approach may be described, generally, as including: 1) breaking down the market into individual competitors, 2) building a model to predict each competitor's price decisions, and 3) aggregating the results in order to make aggregate market predictions. Each of these three general descriptions of the novel approach have various processes and elements included therein that causes this new approach to be highly superior to any other approach or model for predicting competitor behavior in a given market. Thus, present embodiments serve to create a multi-part competitor response model that produces solution sets that reduce the error in competitor response predictions to price change and consequently, provide pricing recommendations that optimize market share and revenue for a given competitor/lender of a group of competitors.

### Competitor Pricing Strategy Determination

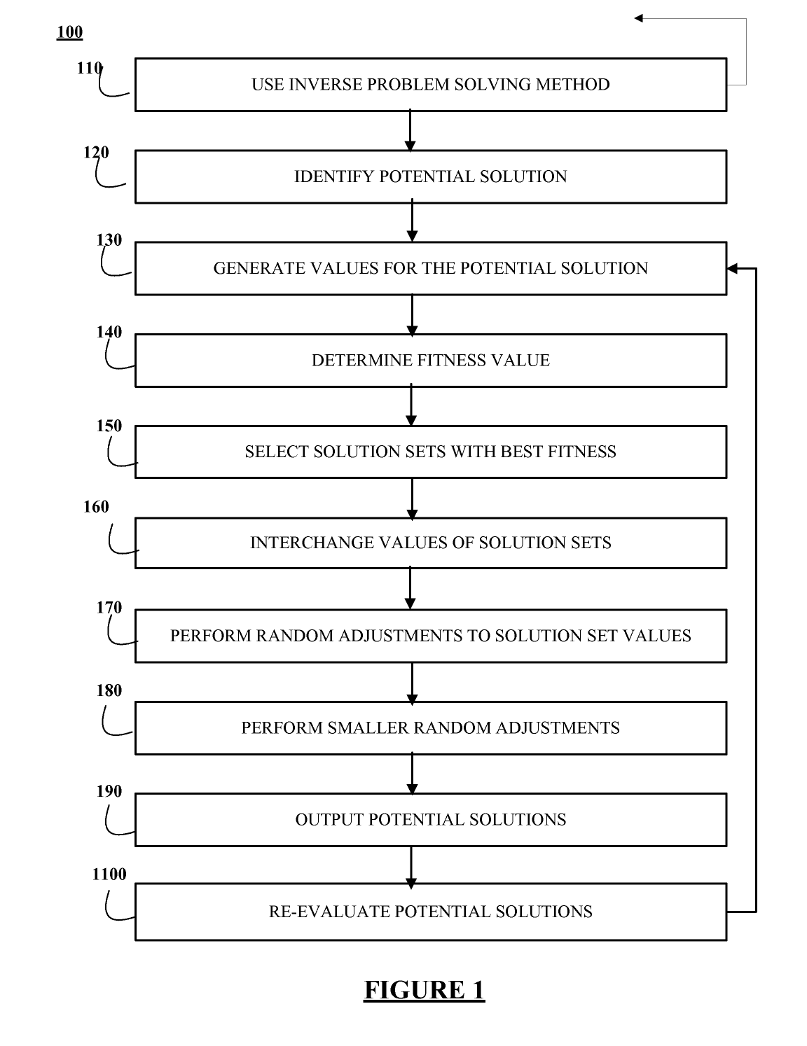

Referring now to FIG. 1, a flow diagram illustrating a general process flow 100 of a system for determining a pricing strategy is provided, in accordance with one embodiment of the present invention. In some embodiments, the system aims to determine a pricing strategy for one or more competitors in a first mortgage market segment (e.g., 30-year fixed conventional mortgage segment). As represented by block 110, the system, using an inverse problem solving method, defines a potential solution or pricing strategy for one or more competitors by identifying one or more variables. The identified variables may include, but is not limited to, one or more price selection methods and a plurality of variables specifying the details of a pricing strategy of a competitor. The pricing strategy of a competitor may sometimes be referred herein, as an “effective strategy,” where the effective strategy may be a set of rules and variables used to approximate the decisions made by an individual competitor. Thus, an effective strategy may be determined by identifying an approximate price selection method used by an individual competitor and determining the individual values of each of the plurality of variables associated with the effective strategy.

Examples of price selection methods may include, but is not limited to, a rank method, a percentile method, a follow the leader method, a revenue optimizer method, external index, market share target, margin target, volume management, rank method for high volume only, and the like. The rank method when used by a competitor as part of an effective pricing strategy requires that the competitor determine a rank order of competitor pricings in a product segment or market segment and then selects one or more of the prices of its competitors based on a position rank of the one or more prices of the competitors. Once a price is selected from the ranks, the competitor may modify the selected price with an add-on of a certain value. The add-on to the selected price may be a positive or negative value depending on where the competitor desires to be positioned in the market segment. As an example, a competitor may determine that three (3) other competitors, A, B, and C, in a specific market segment, such as a 30-year conventional mortgage segment, are pricing the specific product at 1) 4.5%, 2) 4.1%, and 3) 3.95%, respectively. In such an example, the competitor may always select the number two (2) price in the rank and subsequently, add ten basis points (10 bps) to the selected price that results in the competitor pricing its specific product at 4.2% (4.1+0.10 (10 bps)=4.2).

In the percentile method, when used by a competitor for pricing requires that the competitor evaluate a distribution of pricing of competitors for a specific product in the market or market segment. The distribution may be a price v. volume distribution, where the competitor may determine its pricing by selecting the price where 20% of the volume in the market had a lower rate and add on a value to it. For example, when the price at 20% of the volume in the mortgage market at a lower rate is 3.9%, the competitor may select that price and add fifteen basis points (15 bps) to the determined value resulting in a price of 4.05% (3.90+0.15 (15 bps)=4.05) for the product.

The follow the leader method when used by an entity for pricing a product requires that the competitor determine the price that the price leader/competitor in a specific product market or market segment has for the specific product. The entity may use the price value of the leader plus an add-on value in order to determine a price for itself. For example, the leader in price and sales volume in the 30-year conventional mortgage market may currently price the 30-year mortgage at 4.25%. In such an example, the competitor may take that price and add on negative twenty-five basis points (−25 bps) resulting in a price of 4.0% (4.25+(−0.25)=4.0).

When using a revenue optimizer, the competitor selects the price that maximizes revenue, given price elasticity and revenue per lock for a specific product. For example, the competitor may select the price that corresponds to the peak of the revenue by volume curve for a specific product, given two hundred basis points (200 bps) per lock at baseline and a one-percent (1%) change in lock volume per five basis points (5 bps) change in price.

In using an external index as a price selection method, a competitor may select market index or other index, such as LIBOR, and provide an add-on value for determining a price. An index may include a statistical measure of change in an economy or a securities market. In the case of financial markets, an index is an imaginary portfolio of securities representing a particular market or a portion of it. Each index has an associated index value which may be referenced for determining the performance a particular market. As an example, an index value for LIBOR may be 0.25% (which may represent the average rate at which banks borrow money from each other). In such an example, a competitor may be using the external value plus an add-on value of 350 basis points in order to determine a price for a first mortgage in the 30-year conventional mortgage segment. The resulting price would be 3.75% (350 bps+25 bps (0.25%)=375 bps).

In addition to the price selection method types described above, some of the other exemplary variables used in approximating an effective strategy for a competitor are listed and described in Table 1 below:

| Variable Name | Description |
|---|---|
| Margin Minimum | When the margin drops below a |
| | certain value for a specific product, |
| | increase the price to compensate. |
| | Vice Versa may also be used. |
| Volume Maximum | When the volume of sales for a |
| | specific product rises above the |
| | capacity limits of an entity/competitor, |
| | increase the price to lower the volume. |
| Volume Minimum | When the volume of sales for a |
| | specific product drops below a |
| | minimum, lower the price to regain |
| | volume |
| Maximum Daily Change | Maximum price difference allowed |
| | between a historical price and a |
| | current price for a specific product |
| Off-Model Buffer | An amount to increase or lower price |
| | for a specific product when an off- |
| | model condition/occurrence is met |
| Strategy Type | A price selection method for a specific |
| | product |

The variables described in Table 1 may be used in combination with any price selection method in order to determine an effective strategy. In some embodiments, every variable described in Table 1 is used to determine an effective strategy. In other embodiments, every variable in Table 1 is used to describe an effective strategy, where the value corresponding to one or more of the variables is zero or no value at all.

As represented by block 120, after the system identifies a plurality of price selection methods and a plurality of variables specifying the details of an effective pricing strategy of a competitor, a user of the system inputs a potential solution set which may comprise a price selection method and several variables, where the price selection method comprises a first variable component (X) and a second variable component (Y) and where the several variables maybe any one or more of the variables identified in Table 1. In some embodiments, the system determines potential solution inputs in addition to or in lieu of the inputs of the user. In some embodiments, where the solution input is revenue optimizer, the input may have components different than the other identified price selection method strategy types, such as percentile method or follow the leader which may normally have two primary components, such as X=rank and Y=bps add-on. For example, the system may receive a potential solution input of a rank method where the rank method strategy type has, at least, a first variable component (X=rank number) (e.g., rank number=one of 1^{st}, 2^{nd}, 3^{rd}, 4^{th}, and the like) and a second variable component (Y=basis points add-on) (e.g., add-on=one of 25 bps, −25 pbs, 10 bps, and the like). The potential solution, in some embodiments, is an educated guess based on observed past behaviors of a competitor and in some embodiments, may not be a potential solution determination of the system. In other embodiments, the potential solution is, in some embodiments, a determination by the system using other methods, such as regression analysis, statistical modeling, any other form of modeling, and/or a solution from a previous use of the inverse problem method using a genetic algorithm. Thus, in some embodiments, the system determines a potential solution that is used as input for the system. In many embodiments, determining and/or inputting the potential solution for the system initiates an inverse problem solving method used for determining an effective strategy for a competitor. The inverse problem solving method is used in conjunction with one or more algorithms to determine the effective strategy of a competitor. In particular, the system may implement the inverse problem solving method using one or more genetic algorithms in order to determine an effective strategy for a competitor.

Still referring to block 120, in some embodiments, at least a portion of the input or determined potential solutions are predetermined and are added from a previous iteration of strategy determination system described in blocks 110-190. For example, in some embodiments, the system may determine effective strategies for a plurality of competitors where each of the effective strategies comprises potential solution sets with corresponding values. In such an example, the system may analyze the determined effective strategies and select a portion, such as 20% of the results, for input in a new iteration of the inverse problem solving method for determining new potential solution sets. Further in regards to such an example, when the system uses 20% of old previous potential solution sets to determine new potential solution sets, the remaining 80% of the potential solutions are determined in a similar fashion as described in blocks 110-130.

Regarding the analysis for selecting a portion of the previously-determined potential solutions for use in determining new potential solutions, in some embodiments, the selection process is based on the variation of the potential solution sets from the average of the solution set. In an embodiment, the analysis requires that the system first determine an average or mean of the potential solution sets for each individual competitor. After the mean for the potential solution sets is determined, any potential solution sets that fall outside of two standard deviations below the average are automatically eliminated as candidates for selection. Potential solution sets that fall between 0 and 1 standard deviation below the average are assigned a probability of being selected to participate in the portion of potential solution sets to be used in determining a new set of potential solutions. For example, when a potential solution set is one-half (−½) of a standard deviation below the mean, the potential solution set may be assigned a 50% probability of being selected. Any potential solution sets that are above the average are given a 100% probability of being selected, at least, once. Potential solution sets that are 1 standard deviation or more above the average are selected an additional time. In addition to being selected at least once, potential solution sets that fall between 1 and 2 standard deviations above the average are given a probability based on their position. For example, a potential solution set that that is one and one-half (1.5) standard deviation above the average will have the opportunity of being selected at least twice and may be assigned an additional probability of 50% of being selected because it is selected once for being above average, then selected again for being a full standard deviation above average, and provide an additional probability for being a partial standard deviation above a full standard deviation. It will be understood that the probabilities being assigned to potential solution sets that are partial standard deviations away from the average are just examples. The system may dynamically determine probabilities to be assigned to the potential solutions based at least partially on the dispersion of the potential solution sets. In another instances, a user may provide predetermined probabilities for specific ranges of partial standard deviations such that if a potential solution falls within the specified range it will automatically be assigned the probability corresponding to the specified range.

In some instances, the system determines that for determining optimal new potential solution sets a predefined number of previous potential solution sets must be used. In such an instance, when the selection of a predefined number of previous potential solution sets is not satisfied according to the statistical rules relating to the use of standard deviations for selecting prior potential solutions, then the unfulfilled spaces are fit with the very best previous potential solutions. In this way, it maintains selective pressure and thus, forcing the system to generate better potential solutions faster.

Referring now to block 130, the system randomly generates initial values for each variable in each of the potential solution sets. For example, in some embodiments, where a potential solution set includes a rank method for price selection, the system generates values for a first potential solution set X=2^{nd}, Y=25 bps or a second solution set X=3^{rd}, Y=5 bps and/or the like. It will be understood that determining a rank value or position for a variable (e.g., X) is tantamount, in most embodiments, to determining a price value to which a basis points add-on will be summed together with. For instance, if a rank value of 2^{nd} is selected among a plurality of competitors in a segment, it indicates that the system has chosen the price (e.g., 4.0%) or average price that the 2^{nd} ranked competitor currently prices a product in a market segment. Thus, the system determines both a rank value and a basis points add-on value for the price selection method and in addition to, any other variable values in a respective potential solution set.

The system may generate a group of up to and/or more than fifty (50) potential solution sets by randomly generating values, with each potential solution set having a unique combination of values for the variables in the potential solution set meaning that no combination of X, Y values and other variable values in the number of potential solution sets matches the combination of X, Y values and other variable values for another potential solution set in the total number of potential solutions having randomly generated values. It will be understood that some potential solutions may include more than two variables. In fact, some variables within a solution may also have variables for which values or type is determined. For example, price selection method is a variable that is selected from among, as an example, price selection methods including percentile method, rank method, follow the leader, and the like. But, each of the previously-mentioned price selection methods includes two variables, in some embodiments. If rank method is selected, the system must then determine an X and Y value, where X represents a position selected from a rank of competitors and Y represents a basis points add-on.

In other embodiments, the system may receive non-random inputs from a user or from a previously determined set of potential solutions, such that the initial values of the potential solution sets are not completely random. For example, in some embodiments, a user may assign values to variables based on the user's past observations regarding the usefulness or fitness of the assigned values.

The number of potential solution sets having randomly generated values in the group may be determined in several ways. In some embodiments, the system may randomly generate a number of initial values for potential solution sets. However, in such embodiments, the system will only use those potential solution sets with random value that dispersed within a certain range of average actual prices for any identified competitors. Thus, the system may determine or receive a threshold for each competitor as input, such that potential solution sets having randomly generated values that fall outside of those thresholds are not used. As an example, in some embodiments, a potential solution for a competitor may be defined as most likely including a rank method plus an add-on and various other variables. Additionally, it may be determined that the actual price average for the competitor is 4.0% for the relevant market segment and it may also be determined that a threshold of +−12.5 bps should be applied to any potential solution sets. In such an example, the system may generate sufficient initial values such that there are now ten potential solution sets for the competitor. Of those ten potential solution sets, six of the potential solution sets may fall within a range, 3.875% t0 4.125%, as required by the threshold and the other four potential solution sets may fall outside of that threshold. Thus, the potential solution sets that fall within the range defined by the thresholds will participate in the group of potential solutions for that competitor and the others falling outside the range will not. With that said, the group of potential solution sets having randomly generated values may be any number more or less than 50. The number of potential solution sets in the group may depend on the amount of solutions that satisfy the threshold requirements for each competitor. In other embodiments, the number of potential solutions in a group may be capped to a predefined number.

At block 140, the system determines a fitness for each of the potential solution sets having randomly generated values for each of their respective variables. In some embodiments, the fitness is a value indicating or relating to the distance between a price value of each potential solution set and an actual historical price value for a competitor. The value of fitness, in some embodiments, is an absolute value. Thus, the fitness for each of the potential solution sets is determined by testing or evaluating each potential solution set over historical data and comparing the predicted value of a potential solution set to an actual historical value. And, in some embodiments, the historical data is presented on a two-dimensional graph having X, Y dimensions, where the x-axis represents a point-in-time and the y-axis represents a price. Applying a potential solution set to the historical also renders a price for each historical date. As an example, a potential solution set for a competitor may be X=2^{nd} and Y=25 bps and other variables. The historical data may indicate that on a specific date, the rank order, from lowest to highest) of prices of competitors in a specific product market (e.g., 30-year convention mortgage) is 1) 3.75%, 2) 3.85%, 3) 3.9%, and 4) 4.1%. In such an example, applying the potential solution set X=2^{nd}, Y=25 would result in a price of 4.1% (3.85+0.25 (25 bps)). Staying with the example, it may be determined that the historical price for the test competitor's price on that specific day was 4.05%. When comparing the actual value, 4.05%, to the potential solution value, 4.1%, for that specific historical day, the calculated distance between the values is 0.05% or 5 bps. Thus, the value of fitness, in this example, is 5. In some embodiments, the value of fitness may be the average fitness value as determined based on a specified time period, such as one year. This may be done by aggregating the historical price values for a competitor over a specified time period and similarly, aggregating price values for a potential solution set over the same specified time period and subsequently dividing each aggregated value (historical and test) by the number of days in the specified time period for each day there was a historical price and that a test price could be computed. The historical data, in most embodiments, includes historical price data of one or more competitors, wherein the historical price data may be for a specific product or market segment. The historical data may also include competitor identifying information, global and local events that may have impacted pricing, dates and times associated with price changes, the introduction of new products or products related to the specific product market, any additional features of the pricing, such as incentives, pricing promotions, and the like. In some embodiments, the system evaluates the potential solution sets over one year of historical data, as this may produce the best results. It will be understood that the potential solutions may be evaluated over any period of time either greater or longer than one year. The fitness of a potential solution set may also be referred to herein as the objective function or fitness function.

At block 150, potential solution sets having the best fitness values or values of fitness are selected among the plurality of potential solution sets that were evaluated over a specifically defined historical period of time and historical data. The number of potential solutions selected may be any number or a predefined number. The system may determine fitness values for each of the plurality of potential solutions sets over the historical data and calculate/determine an average value of fitness for each potential solution set. Once an average value of fitness is determined for each potential solution set, the system may rank them in order from lowest to highest. In some embodiments, the system may simply select the potential solution sets having the best values of fitness when the average value of fitness for the solution set are the lowest among the plurality of potential solution sets, where, in some embodiments, a lower fitness value indicates a better fit because smaller distances of a test point from an actual historical value is good. For example, where there is fifty potential solutions that have been evaluated over the historical data and where the resulting fitness values range from one to fifty (1-50), the system may select the potential solution set(s) associated with values ranging from one to twenty (1-20) because this range has smaller distances from the actual/historical price for that competitor than the other potential solution sets in the range of one to fifty (1-20). It will be understood that, in some embodiments, fitness can be defined to be the largest distance value from actual data values and does not necessarily have to be the smallest distance value from the actual data values. It will be understood that any number of or predetermined percentage of the potential solution sets may be selected to form a subset for additional testing and evaluation.

Now referring to block 160, after selecting the potential solution sets having the best fitness values, the system may interchange values of the variables of the selected potential solution sets with each other for determining new potential solution sets with characteristics varying from the prior potential solution sets. In some embodiments, the system interchanges values of the variables for each of the selected potential solution sets. And thus, generating new potential solution sets with differing variable values. The interchange of values between variables of differing potential solutions sets is sometimes referred to herein as a “crossover” or a “double crossover.” In a crossover, a first potential solution set (X=2^{nd}, Y=25 bps) exchanges one value of one of its variables with a second potential solution set (X=4^{th}, Y=40 bps) in order to produce a new potential solution set (e.g., X=2^{nd}, Y=40 bps or X=4^{th}, Y=25 bps). In a double crossover, a first potential solution set (X=2^{nd}, Y=25 bps, Z=5%) exchanges more than one value with one or more additional solution sets (X=4^{th}, Y=40 bps, Z=2%) and/or (X=1^{st}, Y=5 bps, Z=10%) in order to create a new generation of solutions. In some embodiments, the crossover and/or double crossover rate among the selected potential solutions sets is a predetermined percentage or amount. For example, in some embodiments, double crossover is limited to a predefined amount of 15% such that not more than 15% of the potential solution sets have interchanged variables.

In other embodiments, a crossover is when the system selects a single point in a list of potential solution sets for competitors and mixes two potential solutions by passing all of the data before that point to a new child solution, and all of the data after that point to a second child solution. In another embodiment, double crossover can mean picking two points to do the same operation as in the crossover.

In some embodiments, the system may further generate new potential solution sets in a process that may be referred to herein as “adoption.” In such a process, the system may randomly replace the values of the variables of a first potential solution set with values of the variables of a second potential solution set. In some instances, the system may implement a full adoption whereby the system replaces all of the values of the variables of the first solution set with the values of all of the variables of the second solution set. Alternatively, in other embodiments, the system may implement a partial adoption of the values in the second solution set.

In one embodiment, the system may also use a process referred to herein as “identity misappropriation” to replace the variables values of a first potential solution set with the variable values of a second potential solution set based at least partially on the fitness of the second potential solution set. Identity misappropriation may be used by the system in instances when the fitness of a potential solution set for a given competitor is poor or below average and the fitness of a potential solution set of another competitor is above average or several standard deviations above average. In such an instance, the system implement an identity misappropriation method between potential solution sets of two competitors in an attempt to improve the fitness of the below average or relatively underperforming potential solution set of a competitor.

Now referring to block 170, in some embodiments the system determines and performs random adjustments to the values of the variables of the new generation of potential solutions. The random adjustments to the values of the new generation of potential solutions are sometimes referred to herein, as a “mutation” and/or a “large mutation.” In these embodiments, the system isolates certain variables of the new generation of solutions and completely changes its value by increasing or decreasing the values of the variables. In some embodiments, the mutation rate among the new generation of potential solutions is a predetermined amount or percentage. For example, in some embodiments, the system receives input indicating an 8% mutation rate should be used. In such an example, the system will randomly isolate 8% of the variables existing in the new generation of potential solutions and change them by increasing or decreasing the values associated with the isolated variables. For example, a Y variable of a potential solution set (X=3^{rd}, Y=5 bps) of the new generation may be isolated and changed from Y=5 bps to Y=10 bps, and this same type of mutation may be done for 8% of the variables that exist in the new generation of potential solutions.

Next at block 180, in some embodiments, the system determines and performs random adjustments to the values of the variables of the new general of potential solutions but that are smaller than the mutations of the values. These smaller adjustments to the values of the new variables are sometimes referred to herein, individually as a “local perturbation” and/or “small mutation.” A local perturbation to a value of a variable is intended to refine the fit of that value according to the historical data. And so, a determination based on historical data is made by the system that some small change either an increase or decrease of the value of the variable should be made that produces a better fit to the historical data. In some embodiments, a local perturbation rate or small mutation rate is provided by the system or input into the system requiring that a predefined amount or predefined percentage of the values of the variables be subject to a local perturbation. As an example, the system receives input indicating that a 7% local perturbation rate should be applied against the variable values of the new generation of potential solutions. In such an example, the system will randomly isolate 7% of the variables existing in the new generation of potential solutions and refine them for fit by increasing or decreasing the values associated with the isolated variables by a small amount (smaller than a mutation). As an example, a Y variable of a potential solution set (X=2^{nd}, Y=9 bps) of the new generation may be isolated and changed from Y=9 bps to Y=10 bps, as this small mutation is a better fit to the historical data, and this same type of local perturbation may be done for 7% of the variable values that exist in the new generation of potential solutions.

At block 190, an output of the potential solution sets are provided. In some embodiments, the system output each of the potential solution sets for each competitor, where the output includes values for each variable of the potential solution sets and may also include the fitness of each solution. In other embodiments, the output of the potential solution sets may be ranked, such that each potential solution set for each competitor is ranked from best to worst fitness or vice versa.

At block 1100, the resulting output of potential solution sets are re-evaluated beginning with the processes of block 140 and through to the processes described in block 190 until a satisfactory outcome is achieved. In some embodiments, a satisfactory outcome is when the fitness of the solutions begins to reach or has reached a plateau such that success iterations through the processes described in blocks 140-190 no longer produce better results or the results are improved nominally (e.g., fitness is less than 2 or 3 bps). In other embodiments, a satisfactory outcome is when the solutions approach, exceeds, is lower than, or reaches a predetermined threshold for fitness. In such an embodiment, the system would compare the fitness values of the potential solutions sets against the predetermined threshold for fitness in order to determine whether the outcomes are satisfactory. The predetermined threshold for fitness may be a predefined amount and/or predefined percentage. In other embodiments, the system determines a satisfactory once a predetermined number of iterations are performed. In one embodiment, a satisfactory outcome is determined based on manual inspection of the results and/or a combination the above.

It will be understood that the system having the process flow 100 can be configured to perform any one or more portions of any embodiment described and/or contemplated herein, including for example, any one or more portions of the process flow 300 described later herein. In addition, the number, order, and/or content of the portions of the process flow 100 are exemplary and may vary. Indeed, the process flow 100, like all of the other process flows described herein, can include one or more additional and/or alternative process flow portions, and the apparatus configured to perform the process flow 100 can be configured to perform one or more additional and/or alternative functions.

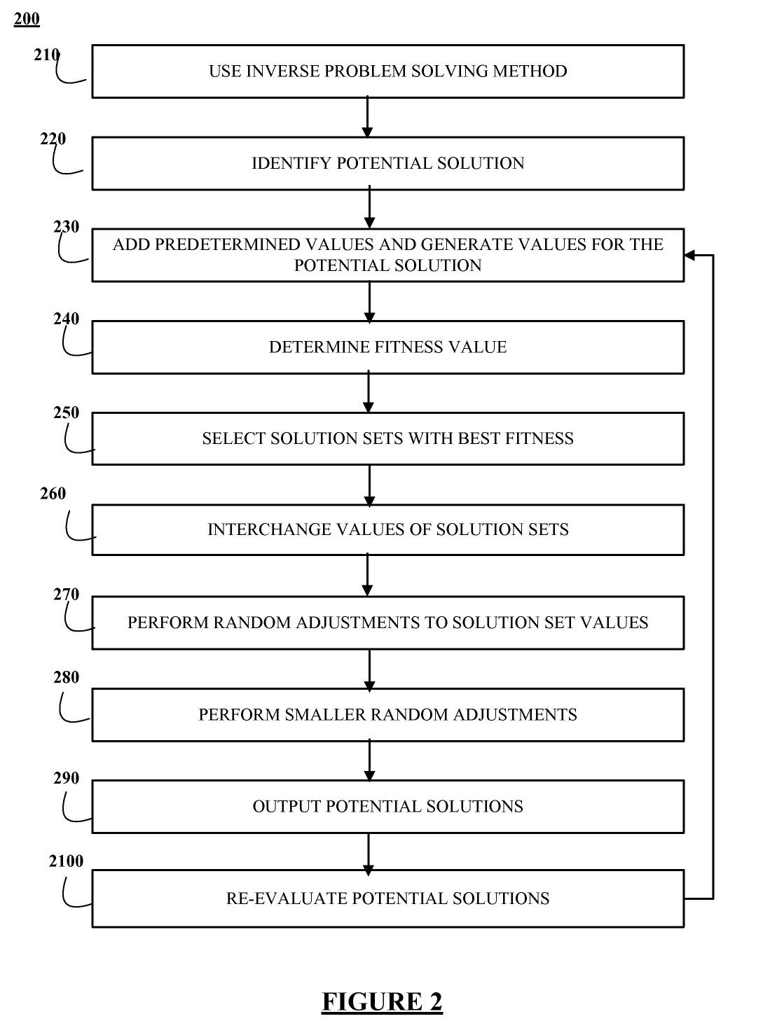

Now referring to FIG. 2, a flow diagram illustrating a modified process flow 200 of a system for determining a pricing strategy of a competitor is provided, in accordance with one embodiment of the present invention. Process flow 200 is similar to process flow 100 in many respects. For instance, blocks 210 to 2200 of process flow 200 are substantially similar to blocks 110 to 1100 of process flow 100.

Except, at block 230, the system populates values of variable for a portion of the potential solutions and determines randomly generated initial values for the unpopulated variables for a specific group and/or generation of potential solution sets. In some embodiments, the system uses values from a previous generation of potential solution sets from a prior iteration of process flows 100 or 200 to populate a portion of the values in the new generation of potential solutions. In many embodiments, the values from the prior generation are values from the potential solutions sets having the fitness among its generation. For example, in an embodiment, the system may populate the initial values of a new generate of potential solution sets with 20% of the values of a previous generation of potential solution sets.

### Reactive Competitor Price Determination

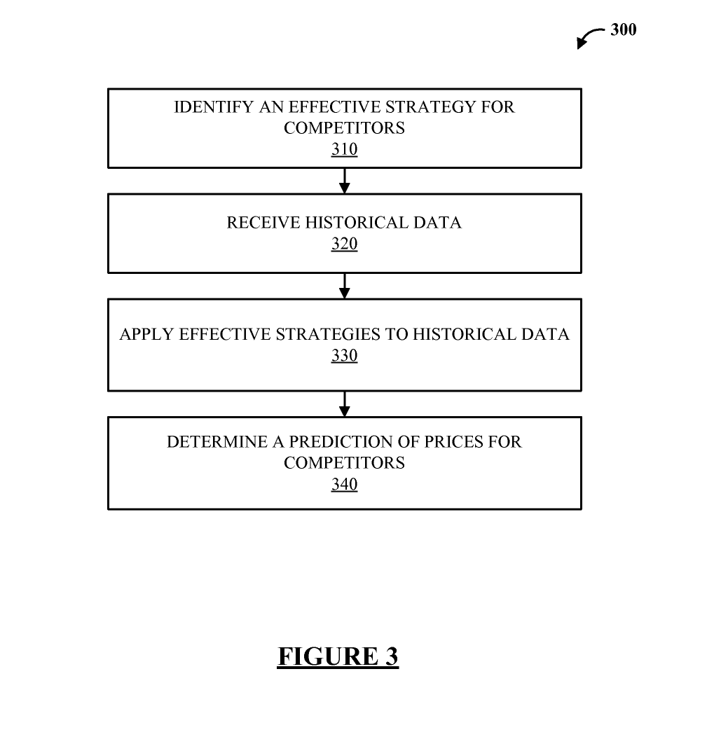

Referring now to FIG. 3, a flow diagram illustrating a general process flow 300 of a system for determining a predicted price or price change of a competitor, in accordance with one embodiment of the invention. The present invention and model can be used to predict prices or price changes of a financial institution's competitors in a specific product market in response to a price change of the financial institution. Using a previously determined effective pricing strategy and recent historical pricing data for each of the financial institution's competitors in a specific product market, the system can simulate/predict future pricing of each of the competitors. In order to determine how the aggregate market will react, the system may use a weighted average price method to determine a relative position of the financial institution's price as compared to the aggregate market.

As represented by block 310, the system identifies an effective strategy for each of the competitors in a specific product market. More particularly, in some embodiments, the system identifies the effective pricing strategy for each of the competitors based on user input. In other embodiments, the system determines the effective pricing strategy for each of the competitors in the specific product market. The effective pricing strategy for each competitor may include a price selection method and various other variables that when applied to historical data of a competitor approximates price values that are substantially similar or the same as historical price values for the competitor. In the instances, when the system determines the effective pricing strategy for each competitor, the process involves an inverse problem solving method that uses a modified genetic algorithm to find a combination of variables that best fits the past behaviors of competitors in a specific market segment.

At block 320, the system receives historical data. The historical data may relate to historical information associated with each of the competitors for which the system is determining a price for a product and/or market segment. Particularly, in some embodiments, the historical data may include pricing information for one or more products and/or services offered by each of the competitors. As an example, the historical information may include pricing data (e.g., interest rates) for a 30-year conventional mortgage for the past year for each of a plurality of financial institutions that compete in the specific product market. The historical data may be for any past period of time (e.g., one week, 3 months, 1 year, or 10 years). The time period used for determining the amount of historical data may be determined by the user or the system. In some embodiments, the system may determine that one year of historical is the optimal time period for inputting into the system. The one year time period may be the immediate one year of historical data as it relates to each of the competitors. The historical data may be received from information internal to one or more of the financial institutions. In other embodiments, the historical data may be received from an external database and/or an external service provider of historical information from competitors operating in specific product markets or in some business area.

At block 330, the system applies each of the identified effective pricing strategies for each of the competitors over the historical data. In an exemplary embodiment, the most recent historical week of pricing data is optimal for predicting prices for each of the competitors. In such an embodiment, the system may only apply the effective pricing strategies over the most recent historical week of pricing data. In applying the effective strategy of each competitor over the historical period of time, the system determines a plurality of effective strategy-based prices.

In some embodiments the information may be presented using graphical means, such as two coordinate system graph, a bar graph, circle graph, histogram, and/or any other type of graph. On the graph, the effective strategy-based prices may be superimposed over the historical prices for each competitor in a specific product market in order to provide a comparison. Thus, a user can easily determine whether the fitness of the effective strategy for a specific competitor is good or bad and/or remove outliers, if necessary. Additionally, the graph may comprise additional information providing a fitness value for the effective strategy for a specific competitor when compared to the actual historical prices for a specific competitor.

Now, at block 340, the system determines a prediction of prices for each individual competitor. Generally, the system predicts prices for each competitor based on an application of an effective pricing strategy for each competitor over a most recent week's historical pricing data. In particular, in some embodiments, the system determines a predicted price for each competitor based on the average of the effective strategy-based prices determined over the most recent week pricing data. For example, the effective pricing strategy for a competitor may be the rank method plus an add-on, such as X=2^{nd} and Y=+10 bps. Staying with the example, applying the effective pricing strategy over the most recent week's historical pricing data, the resulting effective pricing strategy-based pricing for last week may be Monday=3.9%, Tuesday=4.1%, Wednesday=3.9%, Thursday=4.0%, and Friday=4.2%. In such an example, the system may take the average for the five values over the five days for the most recent week for a resulting effective strategy-based price of 4.02%. The system may then use the resulting price of 4.02% as the predicted future price for that competitor. In some embodiments, in addition to the averaging, the system may also weight each price determined for each day based on volume of sales associated with each price for the specific day, as this may provide a more accurate price prediction. It will be understood that the system may use average prices from any historical time period and is not limited to a week. In most embodiments, the system will use average prices from a most recent week because the recency in data used for predicting future price may lend itself to more accurate values for prices for each competitor. The system may predict prices for each competitor for any time in the future (e.g., 1 day, 30 days, 90 days, or 2 years into the future).

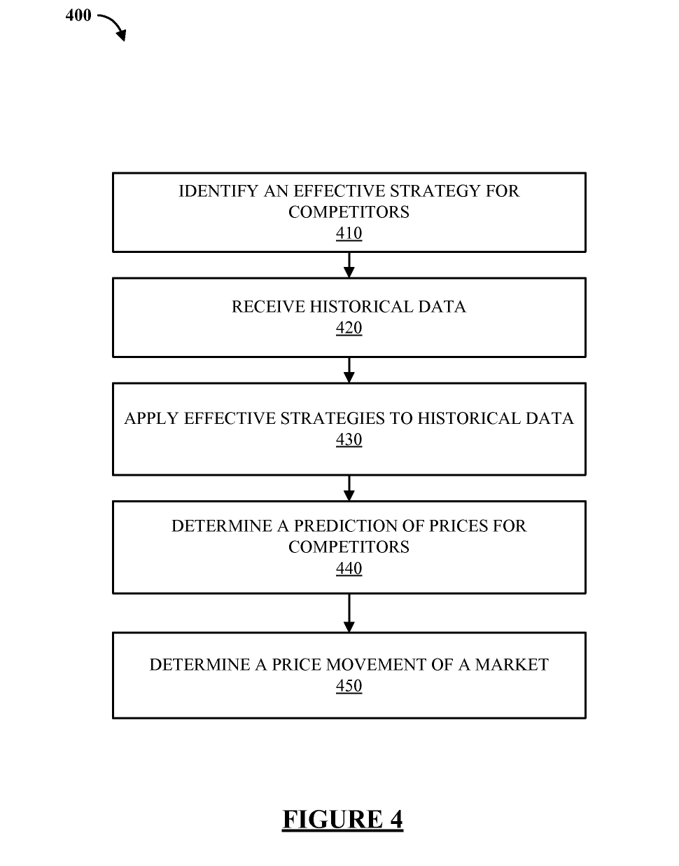

Referring now to FIG. 4, a general process flow 400 of a system for predicting prices for a market, in accordance with one embodiment of the invention. In many embodiments, the market is for a specific product, such as a 30-year fixed conventional mortgage, and comprises several competitors. In such a market, each competitor may have different prices for the specific product and different volumes of sales for the specific product. And so, in some embodiments, the system determines a predicted price or price change for the market based on a weighted average price per volume. Like the system having the process flow 300, the system having process flow 400 is configured to perform similar processes in blocks 410-440 as described at blocks 310-340 of process flow 300.

As represented by block 450, the system having process flow 400 is also configured to determine the price movement of a market. As mentioned earlier, the market may be defined by a specific product, such as 15-year fixed rate mortgage. In other embodiments, the market may be defined by multiple products and segments. In some embodiments, in order to determine the overall price change of a market, the system combines the price predictions for each of the individual competitors participating in the market. In some instances, the system uses a weighted average approach to determine a price or price change of the market. The system may weigh prices of each competitor for a specific product market against market share for the competitors. In many instances, the system may weigh the prices of each competitor based on volume of sales for the specific product. As an example, in a specific product market, such as the 30-year fixed mortgage market with three competitors: A, B, and C the previous week's aggregate sales for the three competitors may be $1,000,000. In such an example, it is determined that A sold $500,000 (50%) of the product, B sold $300,000 (30%) of the product, and C sold $200,000 (20%) of the product and that the average price of sale for each was A=4.1%, B=3.9%, and C=4.5%. In such an example, the system would calculate a price per percentage of the total volume for each of A, B, and C and thus, determine that A=2.05%, B=1.17%, C=0.9% of the total predicted market price of 4.12%.

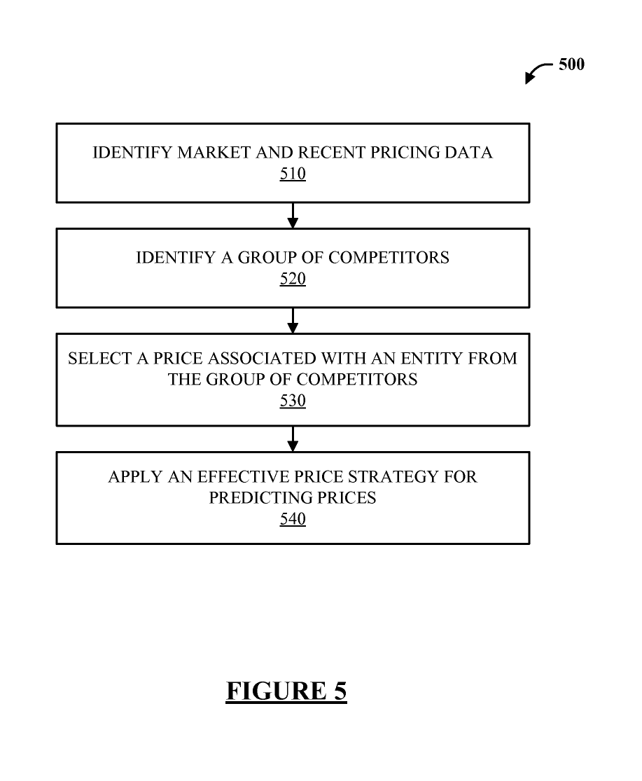

Referring now to FIG. 5, a general process flow 500 of a system for predicting prices of competitors based on or in response to an initial change in price by one of the competitors, in accordance with one embodiments of the invention. At block 510, identifies a specific product or market segment and determines the most recent prices at which each competitor in the identified market offer for sale, sells, and/or participates in the identified market. In some embodiments, the prices may be from the most recent prior week's pricing data. In other embodiments, the most recent prices may be the real-time or substantially real-time prices at which each competitor in a specific market segment is offering for sale, selling, and/or participating in the market segment. In many instances, a plurality of competitors may exist in an identified market, but only a certain portion of the competitors actually affect each other based on price changes and other actions. And so, in some embodiments, the system may only determine most recent prices for a select group of competitors in an identified market segment.

At block 520, the system identifies an entity/competitor from among a group of competitors in the identified market segment for which price change analysis is performed. Thus, based on the price change of the identified entity/competitor, the response of the other competitors in the market segment is measured. In some embodiments, the system identifies the entity/competitor by receiving a selection from a user. In other embodiments, the system identifies the entity/competitor based on a random selection of a competitor from among the group of competitors.

Now, at block 530, the system selects a price associated with the entity from among a group of the most recent prices for the competitors in the market segment and modifies the selected price associated with the entity. The system may modify the selected price for the entity by increasing or decreasing a value of the selected price. As an example, four competitors: A, B, C, and D may be identified as competitors in a specified market segment, such as the 30-year conventional mortgage segment. Subsequently, it is determined that the real-time prices at which each competitor is offering a 30-year mortgage is A=3.8%, B=4.0%, C=3.6%, and D=4.0%. In such an example, the entity/competitor of interest to a user of the system is entity A. The system may modify original/actual price, 3.8%, offered by entity A to 3.5%. Once the price associated with entity A is modified, the system may substitute the original price of 3.8% in the group of most recent prices with the modified price of 3.5%, such that the group of most recent prices is now A=3.5%, B=4.0%, C=3.6%, and D=4.0%. This modified group of most recent prices is used to predict a price change or a price for each competitor without a modified price (B, C, & D) in response to the modified price of the entity (A).

Similar to blocks 330 and 340 of process flow 300, at block 540, the system applies an effective pricing strategy associated with each of the competitors to the modified group of most recent prices in order to predict future prices for each of the competitors in the group including the entity having the modified price. Staying with the previous example, where the modified group of most recent prices is A=3.5%, B=4.0%, C=3.6%, and D=4.0%, the may determine that the effective pricing strategy of competitor B is a rank method plus an add-on, such as X=2^{nd} (ranked lowest to highest) and Y=+20 bps. Applying the effective pricing strategy of competitor B to the data comprising the modified group of most recent prices results in a predicted price for competitor B of 3.8% (3.6% (2^{nd} lowest price in the group)+0.20% (+20 bps)=3.8%). And so, the system predicts that the price for competitor B is 3.8% and will perform the same application of effective pricing strategies in order to determine a predicted price for each of the competitors C and D along with a predicted price for entity competitor A. In some embodiments, the system only predicts a price change for the group of competitors. For example, in some embodiments, the most recent price for competitor B may be 4.0%. In such an example, the system may determine that a predicted price for competitor B is 3.8%. Thus, the system determines that the resulting price change for competitor B is −20 bps or −0.20%, which is the difference between the predicted price and the most recent price for competitor B.

### Competitor Response Model Based Pricing Tool

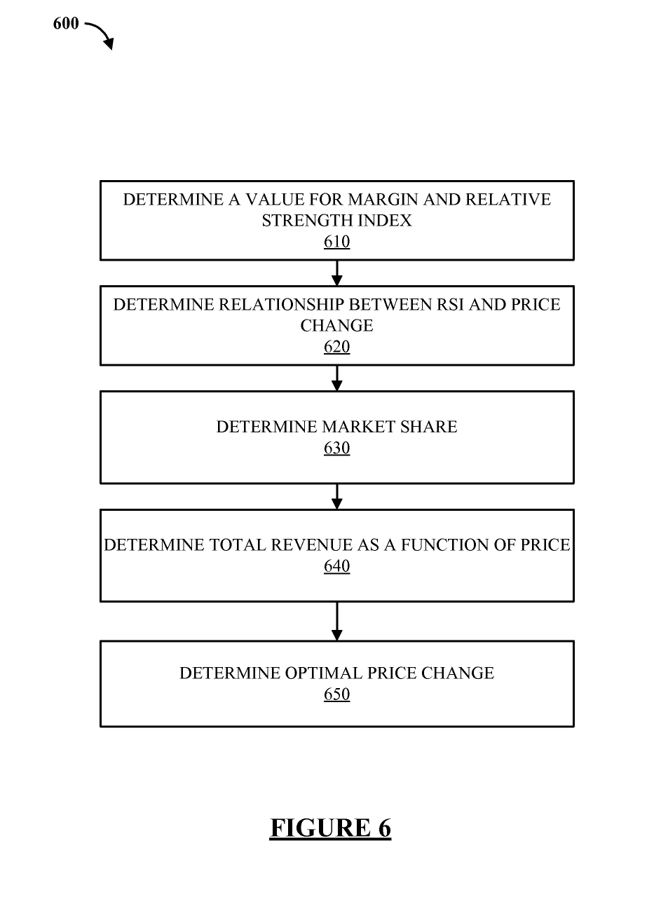

Referring now to FIG. 6, a general process flow of a system for determining price recommendations based on determining a weighted average price for competitors in a specific product market and a resulting relative strength index (RSI) for a competitor, in accordance with one embodiment of the invention. The RSI for a competitor identifies the competitiveness of pricing of a competitor relative to the weighted average pricing of its competitors in a market segment. In order to determine an optimal pricing recommendation, the system determines approximately 601 scenarios based on adjusted values of price for a given competitor in order to determine how the RSI the given competitor will change based on changes of the weighted average price for the other competitors in the market. Of the 601 scenarios, the scenario resulting in the greatest revenue when balanced against market share requirements for the given competitor is most likely the optimal price or price change recommendation for the given competitor.

As represented by block 610, the system determines a margin for an entity and a relative strength index for the entity. The entity for which a margin and relative strength index is determined is often a competitor selected from among the competitors and may also be the entity of concern, meaning the entity that is attempting to determine how its competitors will react to its price changes. The entity may be a financial institution, such as a bank, or some other business entity or business merchant. The margin for the entity is the margin for a specific product, service, or segment offered for sale or sold by the entity. In some embodiments, the margin for the entity is the margin for an overall market segment, such as a 30-year first conventional mortgage segment. In other embodiments, the margin may be the margin for a specific product offered or sold by the entity. Margin may be determined in several ways. A first method for determining margin includes a) determining a price at which the entity is currently selling or has sold the relevant specific product or service, b) determining a cost basis of the entity for offering for sale or selling the specific product or service, and c) calculating a margin for the specific product based on determining the difference between the price of the specific product and the cost basis for the specific product. The cost basis may also be referred to herein as a “cost of goods,” “cost of service,” “cost of funds,” or similar terms used to indicate the cost to an entity for providing the good or service. As an example, a bank may be offering for sale a 30-year conventional mortgage at 3.5% and the bank's cost of funds (e.g., what it costs the bank to borrow the money to lend to a consumer for the mortgage or product) of 1.0%. In such an example, the bank's margin would be 2.5% (3.5%-1.0%), where the margin of 2.5% is the profit the bank would make on the loan, notwithstanding other costs of operating the bank. It will be understood that margin may be an interest rate, a percentage amount/value of a product price, a number amount (e.g., $25 price−$15 cost=$10 margin), or any other financial benefit realized when the amount of revenue gained from the sale of a product or service exceeds the expenses and/or costs for obtaining the product that was sold.

Still referring to block 610, the system also determines the relative strength index of the entity by first determining a weighted average price per volume of its competitors for a specific product and/or market segment. As an example, in a specific product market, such as the 30-year fixed mortgage market with four competitors, including the entity, the other competitors are A, B, and C having an aggregate sales volume of $1,000,000. In such an example, it is determined that A sold $500,000 (50%) of the product, B sold $300,000 (30%) of the product, and C sold $200,000 (20%) of the product and that the average price of sale for each competitor was A=4.1%, B=3.9%, and C=4.5%. In such an example, the system would calculate a price per percentage of the total volume for each of A, B, and C and thus, determine that A=2.05%, B=1.17%, C=0.9% of the total predicted market price per volume of 4.12%. Once the system determines the aggregate weighted average price per volume of the entity's competitors, the system determines the difference in the current price of the entity and the weighted average price per volume of the competitors of the entity. For example, a bank's current price may be 4.25% and the weighted average price (WAP) per volume of its competitors may be 4.12%. In such an example, the relative strength index for the bank is positive 0.13 or +13 basis points (4.25%−4.12%=0.13%). The RSI for the bank is considered to be the difference between the bank's price and the WAP per volume of its competitors. A positive relative strength index value would indicate that the entity/bank is competitively priced in the market, whereas the opposite would indicate that the entity is not competitively priced in the identified market. Also, an increase in the relative strength index value corresponds to a decrease in margin and decrease in note rate (e.g., price of specific product, 4.25%), whereas the opposite corresponds to an increase in margin and increase in note rate.

At block 620, the system uses the competitor response model to determine a relationship between relative strength index for the entity and price change by the entity. In some embodiments, the system uses the competitor response model to predict future prices for the entity, as well as future price of the entity's competitors in an identified market. Individual prices for each competitor may be determined and/or an overall weighted average price for the competitors in the market may also be determined. In such an embodiment, the model simulates the predicted futures prices of the competitors of the entity based on a prospective change in price of the entity. For example, the system may use the model to predict future prices of an entity's competitors when the entity changes or maintains its price to any one of three prices, including 1) 3.75%, 2) 4.0%, and 3) 4.25%. In such an example, the system may determine and/or simulate that the resulting and corresponding predicted future weighted average price change per volume of the entity's competitors are 1) 3.80%, 2) 3.95%, and 3) 4.25%. The results would indicate that when the entity changes its price to 3.75%, the aggregate market or its competitors would price at 3.80%, which is slightly above the price, 3.75%, of the entity. When the entity changes its price to 4.0%, the market would price slightly below and when the entity has a price of 4.25%, the market/competitors would copy its price. The system may use the model to simulate predicted future price changes of competitors based on the entity's price for a predetermined number of times and/or scenarios. In many examples, the predetermined number of times and/or scenarios is 601, as this amount of scenarios may produce optimal results. In some embodiments, the price changes for the simulated scenarios range from −300 basis points to +300 basis points. For example, if an entity's starting price for a mortgage product is 4.0% or 400 basis points then, if using the previously-mentioned simulated scenarios range, the price changes for the scenario may range anywhere between, including the end points, 1.0% to 7.0%. It will be understood that price changes for the simulated scenarios range may be exemplary and the system or a user may use any range necessary for producing useable simulation results.

Still referring to block 620, once the system has modeled weighted average price change of the entity's competitors based on an initial price change by the entity, the system determines a relative strength index of the entity for each simulation. After the relative strength index is determined for each simulation, the system determines a type of relationship that exists between a relative strength index of the entity and price change of the entity. The determination helps explain what occurs to the competitiveness of the entity (RSI) in a specific competitor market of the entity when it changes its prices up or down. It will be understood that the relationship(s) between the relative strength index of the entity and the price change of the entity may be any type of known relationship that may exist between two or more variables, including for example, a causal relationship, a non-causal relationship, correlative relationship, a linear relationship, nonlinear relationship, parabolic relationship, direct relationship, indirect relationship, inverse relationship, negative relationship, positive relationship, a monotonic relationship, non-monotonic relationship, quadratic relationship, and the like. For example, in one embodiment, it may be determined that a decrease in a price for a product offered for sale by the entity, results in a decrease of relative strength index of the entity indicating that there is a direct relationship of some degree between the relative strength index of the entity and price change. Thus, the system analyzes the resulting data in order to provide or present a specific relationship between relative strength index of an entity and price change(s) of the entity in a specific product market.

At block 630, the system determines a market share for the entity based on current elasticity models. The elasticity models may be entity-specific. Also, the elasticity models for the entity may be predetermined elasticity models for specific markets or specific product segments. The entity-specific elasticity models may include a price elasticity model, a demand elasticity model, and/or a relative strength index (RSI) elasticity model. The price elasticity models may compare price v. market share and/or volume, such that it can be presented via a two-dimensional graph. The RSI elasticity models may compare RSI v. market share and/or price, and may be presented via a two-dimensional graph.

Still at block 630, the system or a user may enter one or more prices and/or relative strength indexes for an entity into one or more elasticity models in order to determine a market share value for each of the one or more prices and/or relative strength indexes. The one or more prices and/or relative strength indexes for the entity may be prices and/or relative strength indexes may be determined from the modeling and/or simulations used to determine the relationship between price change and relative strength index for the entity. In some embodiments, each of the one or more elasticity models produces a curve when graphed. In such embodiments, a prospective market share for any price and/or RSI can be determined if it falls on or near the curve. The curves for the elasticity models may be formed between two predetermined value ranges for each of the X and Y axis. In most embodiments, a predetermined price range or predetermined RSI range will form the X-axis, while a predetermined market share range will form the Y-Axis. As such, price inputs or RSI inputs cannot exceed the low-end or high-end of the predetermined ranges for price or RSI, otherwise the model may output ‘invalid’ or a market share that has low useable value.

Once market share based on RSI and/or price for the entity is determined, the system determines a price change by market share curve, where, in one embodiment, price change forms the X-axis and market share forms the Y-axis. In some embodiments, the system may also present the resulting curve in the form of a two-dimensional graph.

At block 640, the system determines total revenue by a function of price change by multiplying margin by market share. In one embodiment, the system multiplies every determined market share value along the price change by market share curve by one or more margin values that results in a total revenue by price change curve. The margin value, in some embodiments, is the margin value determined or input at block 610. In other embodiments, the system determines one or more new margin values and uses that in the total revenue by price change curve determination. In some embodiments, the system may present the resulting total revenue by price change curve in the form of a two-dimensional graph.

Now, at block 650, the system determines an optimal price change for a specific product or product segment based on determining the peak of the curve, where the curve is the total revenue by price change curve for the specific product and/or product segment. In some embodiments, the optimal price change indicates the amount of a price change that would maximize revenue and market share for an entity. For example, a peak of a total revenue by price change curve may be −40 basis points thereby indicating that a margin manager or pricing manager should decrease the current price for a specific product by −40 basis points or 0.4% in order to maximize revenue and market share.

Once the system determines the optimal price change for a specific product, the system provides a price change recommendation and analysis, as output. The price change recommendation, in some embodiments, is the value determined to be the peak of the total revenue by price change curve. For example, the peak of the curve may be −40 bps. In some embodiments, the price recommendation may take into consideration the preferences and decision-making propensities of a pricing manager or margin manager and thus, provide a pricing recommendation that modifies value of the peak of the total revenue by price change curve, accordingly. As an example, the system may use historical data relating to the pricing activities of a pricing manager to modify a peak of the curve value of −40 bps by +5 bps, thereby producing a recommendation of −35 bps. A user of the system may input any preferences, activity data, or historical data that may aid in providing a recommendation.

Still referring to 650, the system may also provide analysis of the pricing recommendation. In some embodiments, the analysis provides a description of how each individual competitor is predicted to react according to an entity's price change. For example, when an optimal price change recommendation is +55 bps, the system may provide analysis indicating that based on the proposed price change a first competitor will change its price by +10 basis points, whereas all of the other competitors may not change their prices at all. The result may be that the entity initiating the price change recommendation may see gains in additional revenue due to the increase in price and maintenance of same market share.

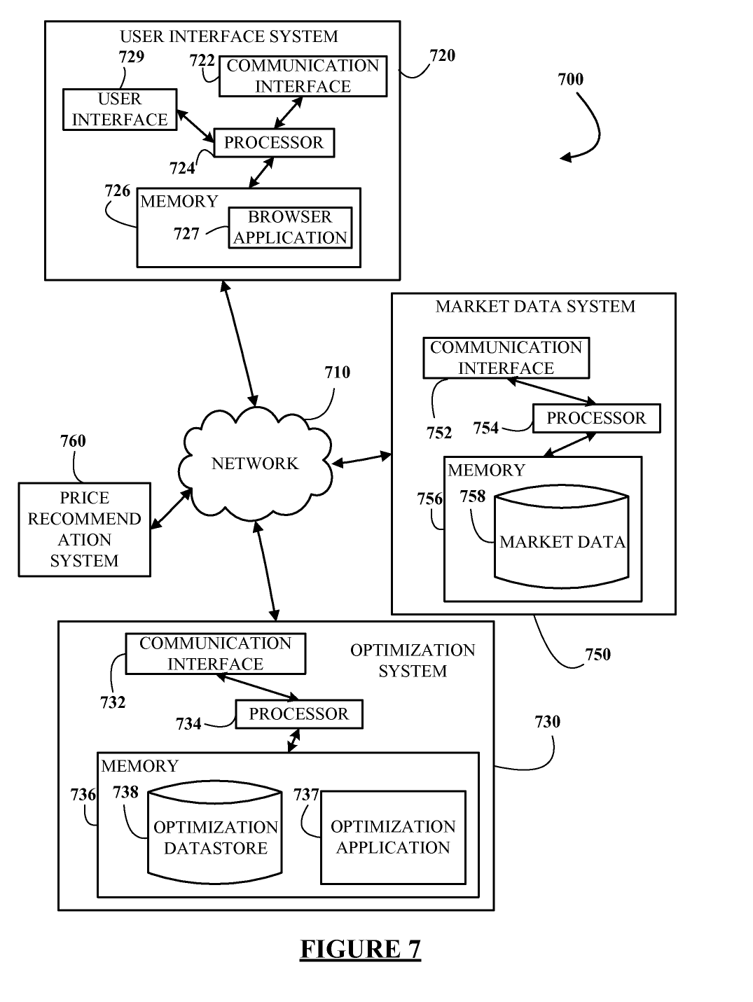

Referring now to FIG. 7, a competitor response model system 700 is provided, in accordance with one embodiment of the present invention. The competitor response model system 700 includes a network 710, a user interface system 720, and a pricing strategy optimization system 730. In some embodiments, the competitor response model system 700 also includes a market data system 750 and a price recommendation system 760. Each of the portions of the competitor response model system 700 is operatively connected to the network 710, which may include one or more separate networks. Additionally, the network 710 may include a direct connection, a local area network (LAN), a wide area network (WAN), and/or a Global Area network (GAN), such as the Internet. It should be understood that the network 710 may be secure and/or unsecure and may also include wireless and/or wireline technology.

In one embodiment, the user interface system 720 is configured to allow a user to communicate with other networks and/or portions of the competitor response model system 700 and/or vice versa. For example, the user may use the user interface system 720 to communicate with the price recommendation system 760 to provide an optimal price recommendation together with competitor analysis or to communicate with the pricing strategy optimization system 730 to request that the pricing strategy optimization system 730 communicate with the price recommendation system 760 to determine an optimal price recommendation automatically in accordance with pricing strategies of an entity's competitors and resulting elasticity models for the entity. It will be understood that the user interface system 720 may be configured to facilitate real-time or substantially real-time communication between the user and other portions of the competitor response model system 700.

It will also be understood that the user interface system 720 may include, for example, a personal computer system, a portion of a computer network, an Internet web browser operated by a processing device, a telephone, a mobile phone, a personal digital assistant, a public kiosk, a fax machine, and/or some other type of communication device. In one embodiment, as illustrated, the user interface system 720 includes a communication interface 722, a processor 724, a memory 726 having a browser application 727 and/or other network communication application, and a user interface 729. The communication interface 722 is operatively connected to the processor 724, which is operatively connected to the user interface 729 and the memory 726 having the browser application 727.

Each communication interface described herein, including the communication interface 722, includes hardware, and, in some instances, software, that enables a portion of the competitor response model system 700, such as the user interface system 720, to transport, send, receive, and/or otherwise communicate information to and/or from one or more other portions of the competitor response model system 700. For example, the communication interface 722 of the user interface system 720 may include a modem, server, and/or other electronic device that operatively couples the user interface system 720 to another electronic device, such as the communication interface 732 of the pricing strategy optimization system 730.

Each processor described herein, including the processor 724, includes circuitry required for implementing the audio, visual, and/or logic functions of that portion of the competitor response model system 700 to which the processor belongs. For example, the processor 724 of the user interface system 720 may include a digital signal processor device, a microprocessor device, and/or various analog-to-digital converters, digital-to-analog converters, and/or other support circuits. Control and signal processing functions of the user interface system 720 may be allocated between these devices according to their respective capabilities. The processor 724 may include functionality to operate one or more software programs based on computer-executable program code thereof, which may be stored, for example, in the memory 726 of the user interface system 720.

Each memory device described herein, including the memory 726 for storing the browser application 727 and other data, may include any computer-readable medium. For example, the memory 726 of the user interface system 720 may include volatile memory, such as volatile random access memory (RAM) including a cache area for the temporary storage of data. The memory 726 may also include other non-volatile memory, which may be embedded and/or may be removable. The non-volatile memory can additionally or alternatively include an EEPROM, flash memory, or the like. The memory 726 can store any one or more pieces of information and/or data used by the user interface system 720 to implement the functions of the user interface system 720.

The browser application 727 may comprise any computer-readable instructions configured to allow the user interface system 720 to communicate with other devices over a network using, for example, one or more network and/or system communication protocols. For example, in one embodiment, the browser application 727 includes an Internet web browser used by the user interface system 720 for communicating with various portions of the competitor response model system 700.

The user interface 729 generally includes one or more user output devices, such as a display and/or speaker, for presenting information to a user. The user interface 729 further includes one or more user input devices, such as one or more keys or dials, a touch pad, touch screen, mouse, microphone, camera, and/or the like, for receiving information from the user.

Also illustrated in FIG. 7 is a pricing strategy optimization system 730, in accordance with one embodiment of the present invention. The pricing strategy optimization system 730 may include, for example, a portion of a computer network, an engine, a platform, a server, a datastore system, a front end system, a back end system, a personal computer system, and/or some other type of computing device. In one embodiment, as illustrated, the pricing strategy optimization system 730 includes a communication interface 732, a processor 734, and a memory 736 having an optimization application 737 and an optimization datastore 738. The communication interface 732 is operatively connected to the processor 734, which is operatively connected to the memory 736 having the optimization application 737 and the optimization datastore 738.

In one embodiment, the optimization application 737 includes computer-executable program code for instructing the processor 734 to receive user inputs and/or historical data about one or more entities that compete in a market segment, for example, the market data system 750 and/or the optimization datastore 738. The optimization application 737 further includes computer-executable program code for instructing the processor 734 to determine one or more pricing strategies investment strategies and/or an optimal price recommendation using any of the methods described herein, such as the methods illustrated in FIGS. 1, 2, 3, 4, 5, and 6. In this regard, in one embodiment, the optimization application 737 includes computer-executable program code for instructing the processor 734 to determine one or more optimized pricing strategies for one or more competitors that compete in a specified market segment. Indeed, it will be understood that the optimization application 737 may include computer-executable program code for instructing the processor 734 to perform any one or more of the events described herein that relate to determining a pricing strategy for an entity/competitor and/or an optimal price recommendation for an entity operating a particular market segment.

As illustrated in FIG. 7, the memory 736 also comprises an optimization datastore 738. In some embodiments, the optimization datastore 738 comprises one or more predefined rules for performing any one or more of the events described herein that relate to determining a pricing strategy for a competitor. For example, the optimization datastore 738 may comprise information relating to an end condition, an optimization period, and/or a backtesting period. In some embodiments, the optimization datastore 738 is configured to store data. For example, in one embodiment, the optimization datastore 738 comprises historical data about one or more competitors in a market segment. The optimization datastore 738 may also be configured to save one or more pricing strategy outcomes and the corresponding variable values that result from using the pricing strategy optimization system 730. It will be understood that, in at least one embodiment, the optimization datastore 738 provides a substantially real-time representation of the data and/or one or more rules contained therein, so that when the processor 734 accesses the optimization datastore 738, the information stored therein is current or substantially current.

In this regard, in one embodiment, the pricing strategy optimization system 730 is configured to constantly, periodically, on occasion, or on request communicate with a market data system 750 to obtain current or historical pricing data associated with one or more competitors/entities. As illustrated, such a market data system 750 may be communicatively connected to the network 710 using a communication interface 752. The market data system 750 generally includes a processor 754 operatively connected to the communication interface 752 that is configured to gather and store historical price data 758 regarding one or more competitors in a memory 756 in real time or near real time.

It will also be understood that, in at least one embodiment, the competitor response model system 700 is configured to implement one or more of the events of process flows 100, 200, 300, 400, 500, and 600.

It will further be understood that some or all of the portions of competitor response model system 700 may be combined into a single portion, i.e. the user interface system 720 and the pricing strategy optimization system 730 may be combined into a single user interface and optimization system configured to perform all of the functions of those separate portions as described herein. Likewise, some or all of the portions of competitor response model system 700 may be separated into two or more distinct portions.

In addition, the various systems of the competitor response model system 700 may be controlled, operated, managed, stored, and/or maintained, etc. (herein “maintained” for simplicity) by the same or separate parties. For example, in one embodiment, a consumer may maintain the user interface system 720, a bank may maintain the pricing strategy optimization system 730, and third parties may maintain the market data system 750 and the price recommendation system 760. As another example, a financial institution may maintain each and every portion of the competitor response model system 700, including any embodiments of the network 710, the user interface system 720, the pricing strategy optimization system 730, the market data system 750, and the price recommendation system 760 as described herein.

As will be appreciated by one of ordinary skill in the art in view of this disclosure, the present invention may be embodied as an apparatus (including, for example, a system, device, computer program product, or any other apparatus), method (including, for example, a business process, computer-implemented process, or any other process), and/or any combination of the foregoing. Accordingly, embodiments of the present invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the present invention may take the form of a computer program product having a computer-readable storage medium having computer-executable program code embodied in the medium.

Any suitable computer-readable medium may be utilized. The computer-readable medium may be, for example but not limited to, an electronic, magnetic, optical, electromagnetic, infrared, or semiconductor system, apparatus, or device. For example, in one embodiment, the computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or other tangible optical or magnetic storage device.

Computer-executable program code for carrying out operations of the present invention may be written in object oriented, scripted and/or unscripted programming languages such as Java, Perl, Smalltalk, C++, SAS, SQL, or the like. However, the computer-executable program code portions for carrying out operations of the invention may also be written in conventional procedural programming languages, such as the “C” programming language or similar programming languages.

Embodiments of the present invention are described below with reference to flowchart illustrations and/or block diagrams of systems, methods, and computer program products according to embodiments of the invention. It will be understood that each block having the flowchart illustrations and/or block diagrams, and combinations of blocks in the flowchart illustrations and/or block diagrams, may be implemented by computer-executable program code. The computer-executable program code may be provided to a processor of a general purpose computer, special purpose computer, or other programmable data processing apparatus to produce a particular machine, such that the computer-executable program code portions, which execute via the processor of the computer or other programmable data processing apparatus, create mechanisms for implementing the functions/acts specified in the flowchart and/or block diagram block(s).

The computer-executable program code may also be stored in a computer-readable memory that can direct a computer or other programmable data processing apparatus to function in a particular manner, such that the instructions stored in the computer-readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the computer-executable program code which executes on the computer or other programmable apparatus provides steps for implementing the functions/acts specified in the flowchart and/or block diagram block(s). Alternatively, computer-implemented steps or acts may be combined with operator or human implemented steps or acts in order to carry out an embodiment of the invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for determining an optimal price recommendation, the system comprising:
a computing platform including at least one processing device and a storage device;
a database comprising historical data, where at least part of the historical data is pricing data associated with plurality of entities, over a historical period of time;
a software module stored in the storage, where the software module comprises executable instructions that when executed by the processing device causes the processing device to:
determine a current value of margin for an entity;
predict one or more values of relative strength index based on one or more price changes;
determine a curve for predicted relative strength index as a function of price change based at least partially on the one or more price changes and predicted one or more values of relative strength index;
use one or more elasticity models to determine one or more values of market share based at least partially on the predicted one or more values of relative strength index to thereby determine a market share as a function of price change curve;
determine a curve for total revenue as a function of price change curve by multiplying the market share of the market share as a function of price change curve by current margin;
determine an optimal price or an optimal price change for the entity based at least partially on a value associated with a peak of the curve for total revenue as the function of price change.

2. The system of claim 1, wherein predicting one or more values of relative strength index comprises:
predicting a future price for the entity;
predicting a future price for each of the competitors of the entity in a specific market segment;
predicting a future weighted average price per volume of sales for competitors of the entity in a specific market segment; and
calculating a value of the difference between the future price for the entity and the future weighted average price per volume for competitors of the entity.

3. The system of claim 1, wherein determining the curve for predicted relative strength index as a function of price change includes simulating 601 different scenarios in which the entity changes it price for a specific market segment, where each scenario includes a result of a value for relative strength index of the entity.

4. The system of claim 3, wherein the price changes for the simulations range from −300 basis points to +300 basis points.

5. The system of claim 1, wherein the processing device is further configured to:
provide an optimal price change and/or an optimal price recommendation for the entity and analysis comprising a description specifying how each competitor of the entity reacts to the optimal price change and/or the optimal price recommendation.

6. The system of claim 1, wherein the one or more elasticity models includes at least one demand elasticity model for a product that is sold or offered for sale by the entity.

7. The system of claim 2, wherein the current value of margin for the entity is based at least partially on a difference between a price value at which the entity sells or offers to sell a product and a cost basis for the product.

8. A method for predicting prices for determining an optimal price recommendation, the method comprising:
using a computer processor comprising computer program code instructions stored in a non-transitory computer readable medium, wherein said computer program code instructions are structured to cause said computer processor to:
determine a current value of margin for an entity;
predict one or more values of relative strength index based on one or more price changes;
determine a curve for predicted relative strength index as a function of price change based at least partially on the one or more price changes and predicted one or more values of relative strength index;
use one or more elasticity models to determine one or more values of market share based at least partially on the predicted one or more values of relative strength index to thereby determine a market share as a function of price change curve;
determine a curve for total revenue as a function of price change curve by multiplying the market share of the market share as a function of price change curve by current margin;
determine an optimal price or an optimal price change for the entity based at least partially on a value associated with a peak of the curve for total revenue as the function of price change.

9. The method of claim 8, wherein predicting one or more values of relative strength index comprises:
predicting a future price for the entity;
predicting a future price for each of the competitors of the entity in a specific market segment;
predicting a future weighted average price per volume of sales for competitors of the entity in a specific market segment; and
calculating a value of the difference between the future price for the entity and the future weighted average price per volume for competitors of the entity.

10. The method of claim 8, wherein determining the curve for predicted relative strength index as a function of price change includes simulating 601 different scenarios in which the entity changes it price for a specific market segment, where each scenario includes a result of a value for relative strength index of the entity.

11. The method of claim 10, wherein the price changes for the simulations range from −300 basis points to +300 basis points.

12. The method of claim 8, further comprises computer program code instructions are structured to cause said computer processor to:
provide an optimal price change and/or an optimal price recommendation for the entity and analysis comprising a description specifying how each competitor of the entity reacts to the optimal price change and/or the optimal price recommendation.

13. The method of claim 8, wherein the one or more elasticity models includes at least one demand elasticity model for a product that is sold or offered for sale by the entity.

14. The method of claim 9, wherein the current value of margin for the entity is based at least partially on a difference between a price value at which the entity sells or offers to sell a product and a cost basis for the product.

15. A computer program product for determining an optimal price recommendation, the computer program product comprising a non-transitory computer-readable storage medium having computer-readable program code stored thereon, such that when the computer-readable code is executed by a computer processor it causes the computer to:
determine a current value of margin for an entity;
predict one or more values of relative strength index based on one or more price changes;
determine a curve for predicted relative strength index as a function of price change based at least partially on the one or more price changes and predicted one or more values of relative strength index;
use one or more elasticity models to determine one or more values of market share based at least partially on the predicted one or more values of relative strength index to thereby determine a market share as a function of price change curve;
determine a curve for total revenue as a function of price change curve by multiplying the market share of the market share as a function of price change curve by current margin;
determine an optimal price or an optimal price change for the entity based at least partially on a value associated with a peak of the curve for total revenue as the function of price change.

16. The computer program product of claim 15, wherein predicting one or more values of relative strength index comprises:
predicting a future price for the entity;
predicting a future price for each of the competitors of the entity in a specific market segment;
predicting a future weighted average price per volume of sales for competitors of the entity in a specific market segment; and
calculating a value of the difference between the future price for the entity and the future weighted average price per volume for competitors of the entity.

17. The computer program product of claim 15, wherein determining the curve for predicted relative strength index as a function of price change includes simulating 601 different scenarios in which the entity changes it price for a specific market segment, where each scenario includes a result of a value for relative strength index of the entity.

18. The computer program product of claim 17, wherein the price changes for the simulations range from −300 basis points to +300 basis points.

19. The computer program product of claim 15, further comprising computer-readable code that when executed by a computer processor causes the computer to:
provide an optimal price change and/or an optimal price recommendation for the entity and analysis comprising a description specifying how each competitor of the entity reacts to the optimal price change and/or the optimal price recommendation.

20. The computer program product of claim 15, wherein the one or more elasticity models includes at least one demand elasticity model for a product that is sold or offered for sale by the entity.
